(19) United States
(12) Patent Application Publication
(10) Pub. No.: US 2005/0223618 A1
(43) Pub. Date: Oct. 13, 2005

(54) Intelligent submersible device for locating and intercepting marine species for control and harvesting

(76) Inventor: Jack C. Mueller, Carrollton, TX (US)

Correspondence Address: MICHAEL L. DIAZ, P.C., 555 REPUBLIC DRIVE, SUITE 200, PIANO, TX, 75074, US

(21) Appl. No.: 11/090,748

(22) Filed: Mar. 24, 2005

Related U.S. Application Data
(63) Continuation-in-part of application No. 10/134,809, filed on Apr. 29, 2002, now Pat. No. 6,760,995.
(60) Provisional application No. 60/560,808, filed on Apr. 8, 2004.

(51) Int. Cl. A01K 85/00

(52) U.S. Cl. 43/26.2; 43/43.13; 43/4; 43/26.1

(57) ABSTRACT

The present invention provides an autonomous submersible device which can locate, intercept, control and/or gather various marine species. The submersible device includes an intelligence module which can detect, develop a plan to intercept or control the detected marine species, as well as capture the marine species. The submersible device may work alone or in combination with other submersible devices. In addition, the submersible device may be towed by a ship or be self-propelled. The submersible device may optionally include a communication system to communicate with a remotely located supervisory control system and/or the user. The submersible device also includes sensor equipment for detecting the marine species. The submersible device is controlled through the utilization of a plurality of moveable control surfaces, ballast tanks, or other control mechanisms commonly used by underwater submersibles. The intelligence module in each submersible device may communicate with the user and/or an information gathering and control system.

### RELATED APPLICATIONS

This nonprovisional application claims priority based upon the prior U.S. provisional patent application entitled “ROBOTIC MARINE LOCATING, CONTROL AND HARVESTING DEVICES,” application No. 60/560,808, and is a continuation-in-part of a U.S. patent application Ser. No. 10/134,809 now issued U.S. Pat. No. 6,760,995 by Jack C. Mueller entitled “ELECTRONIC FISHING DEVICE STEERABLE IN AZIMUTH AND DEPTH BY REMOTE CONTROL OR PREPROGRAMMED INSTRUCTIONS,” filed Apr. 29, 2002 and is hereby incorporated in its entirety by reference herein.

### BACKGROUND OF THE INVENTION

1. Field of the Invention

This invention relates to marine equipment. Specifically, and not by way of limitation, the present invention relates to a submersible robotic device having intelligence to locate and intercept marine species for control and harvesting of the marine species.

2. Description of the Related Art

As discussed in U.S. Pat. No. 6,760,995 to Mueller (Mueller), the general methods of fishing can be divided into two broad categories: (1) fishing with a lure or baited hook, and (2) fishing with a net or trap. Sport fishermen generally use a fishing method in the first category, and may fish from the shore of a lake or river or may fish from a boat. While boat fishing, the boat may be stationary, or the boat may move while the lure or bait is trolled behind the boat. Common problems experienced by sport fishermen arise from the fact that the fishermen have limited control over the positioning of the lure in the water. For depth control, a float may be positioned on the fishing line at a distance from the lure equal to the desired depth. However, this method is not accurate when the lure is moving through the water. Some lures may have control surfaces that cause the lure to dive when it is pulled through the water. Therefore, the depth of the lure may be roughly determined by the speed of the bait or lure. However, this technique is also not very accurate. Azimuth control is generally determined by the direction in which the fisherman casts and/or retrieves the bait or lure. Once it is in the water, however, the bait or lure is limited to traveling a direct line between the bait or lure and the fisherman as it is reeled in.

Commercial fishermen may use hook lines or may use a method in the second category (i.e., fishing with a net/trap). Outriggers and/or downriggers may be utilized to deploy the hook lines. Outriggers and downriggers utilize an underwater foil connected to the lines, and the speed generated by the trawler causes the foil to pull the hook lines outward from the side of the trawler, or to pull the lines to a desired depth, respectively. The use of outriggers and downriggers requires that the trawler maintain sufficient headway to provide the necessary force on the foils to properly deploy the lines. In an alternative method, the trawler may let out a length of net behind the trawler using electric wenches, and the trawler may then steam in a circle to enclose a school of fish with the net. This method of deploying a net also requires that the trawler maintain sufficient headway to avoid tangling the net.

Mueller discloses an electronic fishing device that can be steered in azimuth and depth by remote control or by preprogrammed instructions. However, although preprogrammed instructions are utilized by the fishing device, an intelligence module would be advantageous to allow the fishing device to autonomously locate and intercept marine species.

Thus, it would be a distinct advantage to have a submersible device having a self-contained intelligence for the purpose of locating, intercepting, capturing and/or controlling marine species. It is an object of the present invention to provide such an apparatus and method.

### SUMMARY OF THE INVENTION

In one aspect, the present invention is a submersible device for interacting with a marine species. The submersible device includes a main body housing an intelligence module. The submersible device is maneuverable underwater and includes sensor equipment for detecting marine species. The intelligence module is programmed to maneuver the submersible device in a desired pattern to accomplish a desired course of action upon detection of a marine species. The submersible device may be used to direct the marine species to a desired location, intercept the marine species, or capture the marine species. The submersible device may be towed or self-propelled. In addition, the submersible device may work with other submersible devices to interact with the marine species.

In another aspect, the present invention is a system for interacting with a marine species. The system includes a plurality of submersible pods. Each submersible pod includes a main body housing an intelligence module. The submersible pod is maneuverable underwater and includes sensor equipment for detecting the marine species. The intelligence module is programmed to maneuver the submersible pod in a desired pattern for a desired course of action with the marine species upon detection of a marine species. A controller is used for coordinating the plurality of submersible pods to maneuver in a desired pattern to accomplish the desired course of action with the marine species.

In still another aspect, the present invention is a method of interacting with a marine species. The method begins by maneuvering a submersible device underwater. The submersible device searches for the marine species. Upon detection of the marine species, an intelligence module in the submersible device calculates a course of action. Next, the submersible device executes the course of action. The course of action may include intercepting, capturing or controlling the marine species. The submersible device may work in coordination with other submersible devices.

### BRIEF DESCRIPTION OF THE DRAWINGS

FIG. 1 is a side view of a submersible lure in a first preferred embodiment of the present invention;

FIG. 2 is a side view illustrating the internal components of the submersible lure of FIG. 1;

FIG. 3 is a flow chart outlining the steps for utilizing the submersible lure of FIG. 1 according to the teachings of the present invention;

FIG. 4 is a side view of an autonomous submersible device in a second embodiment of the present invention;

FIG. 5 is a side view illustrating the internal components of the submersible device of FIG. 4;

FIG. 6 is a flow chart outlining the steps for utilizing the submersible device of FIG. 4 according to the teachings of the present invention;

FIG. 7 is a side view illustrating the internal components of a submersible pod in the third embodiment of the present invention;

FIG. 8 is a simplified block diagram of the components of a control system employing a plurality of submersible pods of FIG. 7;

FIG. 9 is a side perspective view of a plurality of submersible pods of FIG. 7 operating underwater to control a school of fish;

FIGS. 10A and 10B are flow charts outlining the steps for utilizing the submersible pod of FIG. 7 according to the teachings of the present invention;

FIG. 11 is a side perspective view of the internal components of a submersible pod in the fourth embodiment of the present invention;

FIG. 12 is a simplified block diagram of the components of a control system employing a plurality of submersible pods of FIG. 11;

FIG. 13 is a side view of a plurality of submersible pods of FIG. 11 in the maintenance/search mode in the fourth embodiment of the present invention;

FIG. 14 is a side perspective view of the plurality of submersible pods of FIG. 11 in the intercept mode;

FIG. 15 is a side perspective view of the submersible pods of FIG. 11 in the capture mode; and

FIGS. 16A and 16B are flow charts outlining the steps for utilizing the submersible pods of FIG. 11 according to the teachings of the present invention.

### DESCRIPTION OF THE INVENTION

The present invention is an intelligent submersible device for the purpose of locating, intercepting, and capturing marine species. The device can be towed or self-propelled. It can be used as a fishing lure with hooks attached or a device that tows a catching device, i.e., artificial or natural bait, a net, or other similar devices. The device can operate independently or in conjunction with other submersible devices. The device may be programmed via a communications link to a controlling module and then operate in a totally autonomous mode. The device may operate in a totally autonomous mode because the device includes an intelligence module having a processor providing intelligence for detecting, targeting, and controlling the movement of the device (e.g., speed, depth, and azimuth) to intercept, capture, and/or control the movement of marine species (e.g., fish). The submersible device may incorporate internal marine species detection equipment such as sonar equipment, visual acquisition equipment and other sensor equipment as required to detect the marine species. In alternate embodiments, the device may be in different sizes and capabilities and intelligence depending on the application of the submersible device.

The submersible dive may be maneuvered in depth or azimuth by a plurality of control surfaces extending from the device into a surrounding body of water, and electromechanical control mechanisms for moving the control surfaces. Depth control may be performed through a combination of device buoyancy and movement of the control surfaces. The submersible device, if self-propelled, may include a propulsion system common in many different types of submersibles.

The submersible devices all include an intelligence module allowing preprogrammed movement of the submersible as well as providing the option of being totally autonomous and/or remotely controlled. The submersible device is equipped with an internal power component, one or more sensor arrays and optional communication capabilities to fit their mission requirements. The size, power and performance of each element are designed to meet its operational requirements.

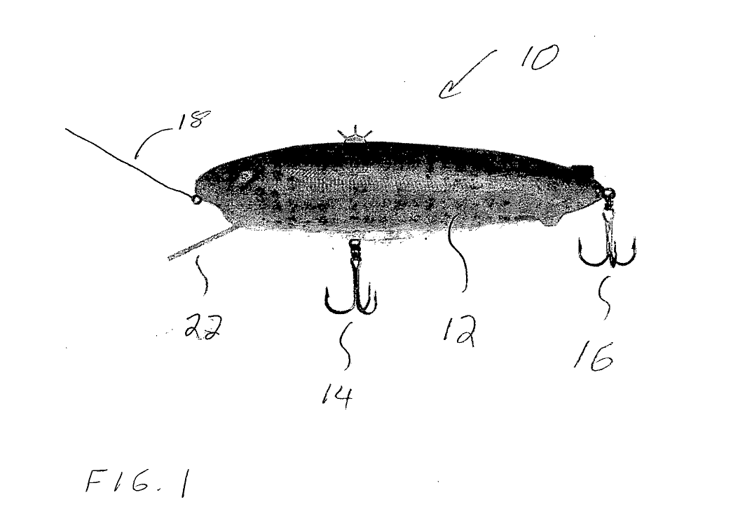

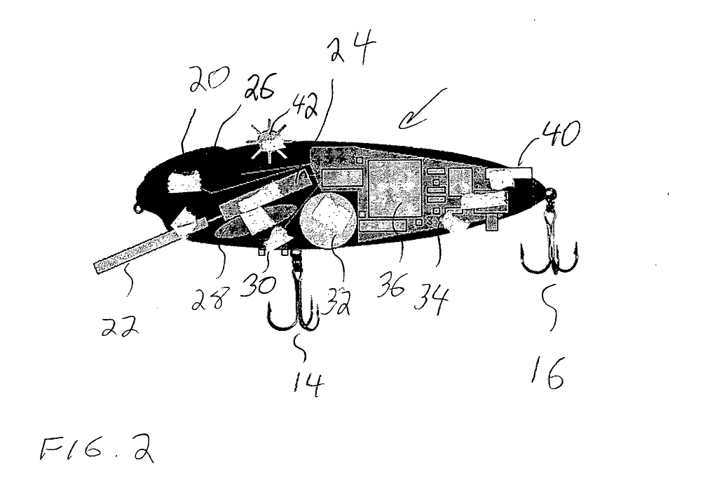

FIG. 1 is a side view of a submersible lure 10 in a first preferred embodiment of the present invention. The submersible lure 10 includes a main body 12 having a plurality of attached hooks 14 and 16. The lure 10 may be pulled by a line 18. Although FIG. 1 provides one configuration, it should be understood that the submersible lure 100 may be in a wide variety of sizes, shapes and colors, although the functionality of the equipment carried by the submersible device remain the same.

FIG. 2 is a side view illustrating the internal components of the submersible lure 10 of FIG. 1. The submersible lure may include a power “on” LED 20 for indicating when the submersible lure is powered. The submersible lure may be maneuvered in its depth by a diveplane 22 driven by a diveplane actuator 24 and through the use of ballast 28. A sensor capability may include a sonic transducer 26 for communication and sonar. The submersible lure may also use radio frequencies (RF) for communication. The submersible lure may be powered automatically when water contacts the water contact power switch 30. In addition, the submersible lure may also include a battery 32, a control surface board 34 having an intelligence module 36, and a pressure sensor 38. The submersible lure may also include an interface connector 40 and a speed detector 42.

The submersible lure 10 incorporates many of the features and configurations of conventional lure by having the main body 12 and a plurality of hooks for capturing fish. However, the present invention includes several features not incorporated in conventional lure. The submersible lure may controls its depth and azimuth by the diveplanes and/or other control surfaces attached to the main body of the submersible device.

With reference to FIGS. 1 and 2, the operation of the submersible lure 10 will now be explained. The intelligence module 36 will be programmed with operational information for operating in the water. For example the operational information may include cruise depth, maximum depth, sensory data on the targeted species, and an approach pattern to be taken by the submersible lure when a targeted marine species is detected. The operational information may also provide a series of depths and cruising patterns to be used when the submersible lure is operating prior to a sensory contact by the lure. The submersible lure is preferably towed through the water. The lure continuously scans the water in search of the targeted marine species, e.g., fish. The sensors may include sonar sensors or any sensor enabling the lure to detect the marine species. Upon detection of the targeted marine species, the submersible lure calculates an interception path and executes the interception path and pattern programmed within the intelligence module 36. The intercept of this submersible lure is internally controlled by the intelligence module and is designed to go as near the marine species and in a movement manner that the user established during the preprogramming stages. Thus, the user of the submersible lure can manage the lure's approach to the marine species, thereby increasing the likelihood of a strike and catching the marine species. The depth control may be performed through a combination of device buoyancy (ballast) and/or the movement of control surfaces.

In an alternate embodiment of the submersible lure, rather than towing the submersible lure, the lure may be self-propelled by a propulsion system (not shown). The lure may be remotely controlled or preprogrammed to maneuver in a specific manner for a specific period of time. A termination command may be remotely provided to the lure or the lure may automatically terminate after a predetermined time period.

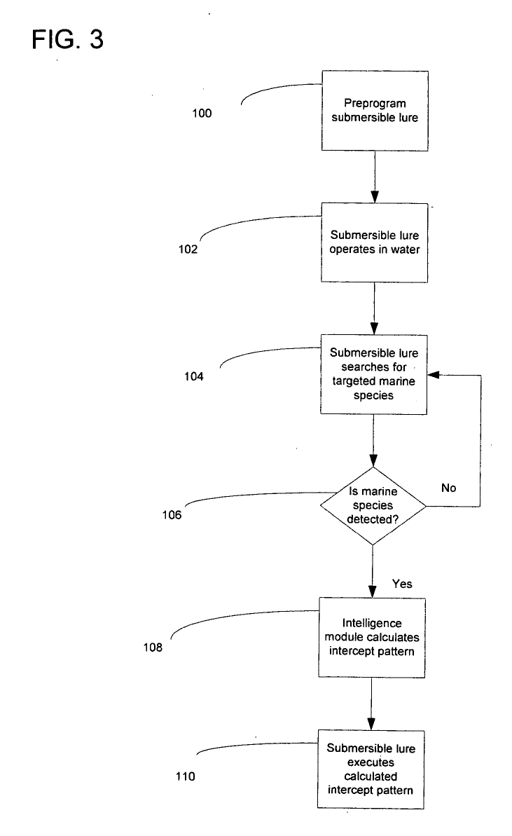

FIG. 3 is a flow chart outlining the steps for utilizing the submersible lure of FIG. 1 according to the teachings of the present invention. With reference to FIGS. 1-3, the steps of the method will now be explained. In step 100, the submersible lure 10 is preprogrammed with all necessary operational data to operate within the water. For example the operational data may include information on pre-contact searching patterns and depths for the submersible lure to operate. In addition, the employment of the sensor equipment may be programmed for detecting marine species as well as identifying a targeted marine species, such as fish. The submersible lure may also be programmed to calculate an intercept pattern for the submersible lure to operate upon detection of the targeted marine species. Next, in step 102, the submersible lure is operated within the water. The submersible lure is preferably towed within the water. However, in an alternate embodiment of the submersible lure, the lure may be self-propelled. In step 104, the submersible lure searches for the targeted marine species. In step 106, it is determined if the marine species is detected. If the marine species is not detected and identified by the intelligence module 36, the submersible lure goes to step 104 where the submersible lure continues to search for the targeted marine species.

However, in step 106, if the submersible lure detects and identifies the targeted marine species, the intelligence module 36 calculates an intercept approach to the detected marine species. Next, in step 108, the submersible lure executes the calculated intercept approach. This approach is calculated in such a manner to optimize the chances of enticing the marine species to strike and the lure to capture the targeted marine species. In step 110, the submersible lure executes the calculated intercept approach to the detected marine species.

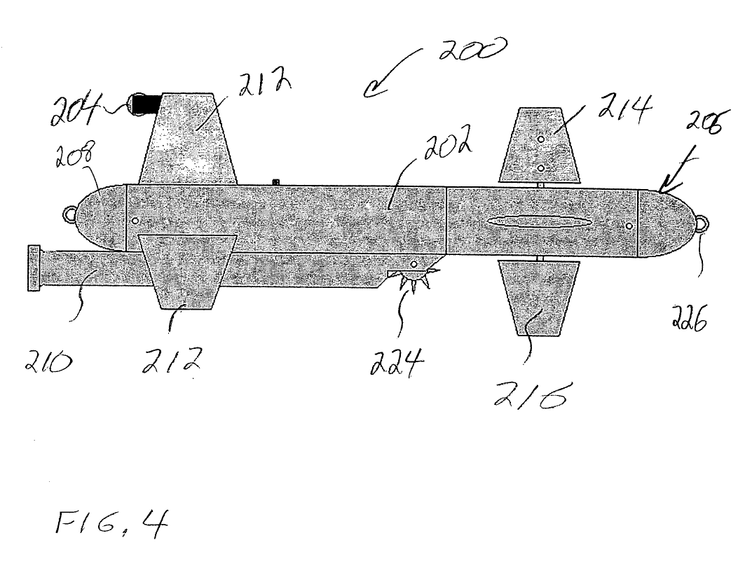

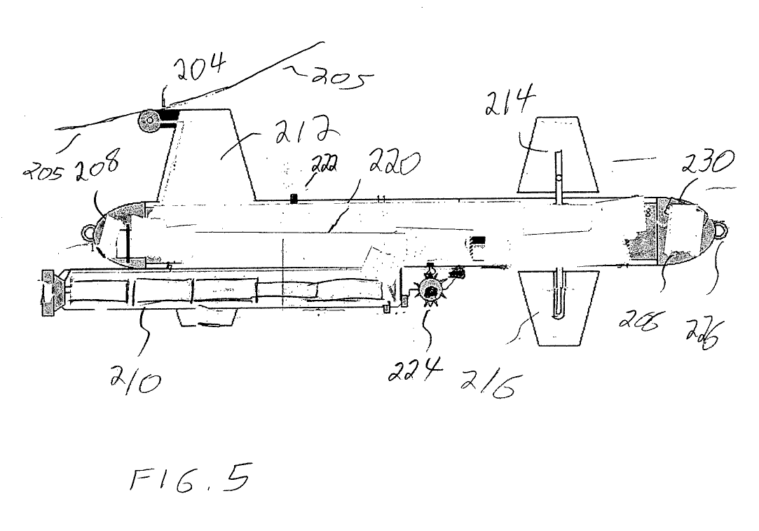

FIG. 4 is a side view of an autonomous submersible device 200 in a second embodiment of the present invention. The autonomous submersible device may tow a catching device, such as artificial bait, natural bait, a net, or other similar devices. Although FIG. 4 provides one configuration, it should be understood that the submersible device 200 may be in a wide variety of sizes, shapes and colors, although the functionality of the equipment carried by the submersible device remain the same. The submersible device is towed through the water while scanning the water for the selected marine species with its sensors.

FIG. 5 is a side view illustrating the internal components of the submersible device 200 of FIG. 4. The submersible device includes a main body 202. Located on an aft portion of the main body is a fishing line clip 204 with line detachment detection for towing a separate bait or net (not shown) attached to a fishing line 205. The fishing line 205, in the preferred embodiment originates upon a surface vessel and runs down through the fishing line clip. The fishing line then is extended out from the fishing line clip to a separate bait, lure or net. Preferably, when a fish or other marine species strikes the bait/lure, pressure from the strike causes the fishing line to pull out from the fishing line clip, thereby detaching the fishing line from the submersible device. The submersible device may be programmed to maneuver away from the area to provide a clear space for the fishing line. Additionally, the fishing line clip may include a detector which detects when the bait/lure attached to the fishing line is detached from the fishing line. If the bait or lure is detached, a signal may be sent to the submersible device and/or surface vessel where appropriate action may be initiated to hook and land the species or reattach the line/bait in the clip. The main body includes a nose cone 206 and a tail cone 208. The submersible device is powered by a battery or batteries 210. The main body may also support a plurality of rudder blades 212, 214 and 216. The submersible device may include a circuit board having an intelligence module 220. The intelligence module includes a microprocessor. The submersible device may also include a power “on” LED indicator 222. To detect the speed of the submersible device, a speed paddle wheel 224 may be used. The submersible device may be towed by a line attached to a tow ring 226.

The rudder blades may act as control surfaces for moving the submersible device 200 within the water. The rudder blades may be moveable. The submersible device may also include dive planes and ballast for depth control (not shown). The submersible device also includes a communications and sonar transducer 230 and/or a RF transceiver for communication.

With reference to FIGS. 4 and 5, the operation of the submersible device 200 will now be explained. The submersible device 200 provides an autonomous underwater device that tows a catching device (not shown), such as artificial or natural bait, a net or other similar devices for catching various marine species. The intelligence module 36 is programmed with operational information for operating in the water. For example the operation information may include cruise depth, maximum depth, sensory data on the targeted species, and an approach pattern to be taken by the submersible device when a targeted marine species is detected. The operational information may also provide a series of depths and cruising patterns to be used when the submersible device is operating prior to a sensory contact by the lure. The submersible device is preferably towed through the water. The submersible device continuously scans the water in search of the targeted marine species, e.g., fish. The sensors may include sonar sensors or any sensor enabling the submersible device to detect the marine species. Upon detection of the targeted marine species, the submersible device calculates an interception path and executes the interception path and pattern programmed within the intelligence module 36. The intercept of this submersible device is internally controlled by the intelligence module and is designed to go as near the marine species and in a manner that the user established during the preprogramming stages. Thus, the user of the submersible device can manage the lure's approach to the marine species, thereby increasing the likelihood of catching the marine species by the towed catching devices. The depth control may be performed through a combination of device buoyancy (ballast) and/or the movement of control surfaces (rudder blades).

In an alternate embodiment of the submersible device 200, the submersible device may be self-propelled by a propulsion system (not shown). The submersible device may be remotely controlled or preprogrammed to maneuver in a specific manner for a specific period of time. A termination command may be remotely provided to the lure or the lure may automatically terminate after a predetermined time period. Upon termination, the submersible device may resume its previous course or operation.

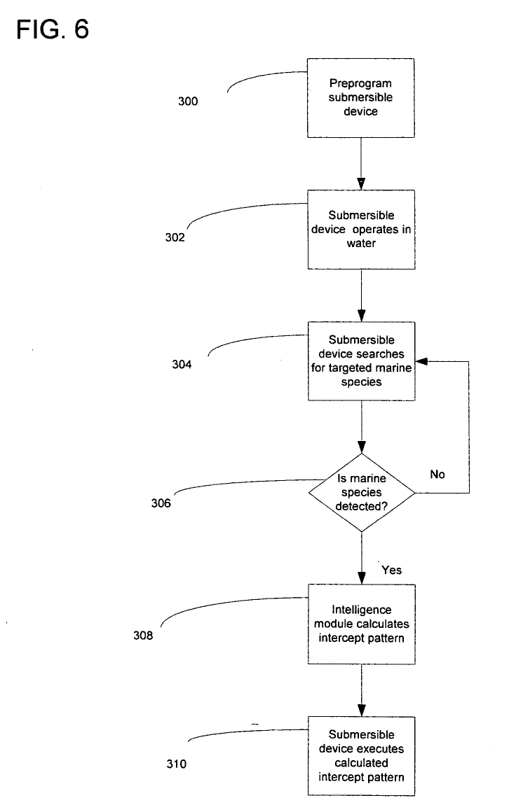

FIG. 6 is a flow chart outlining the steps for utilizing the submersible device of FIG. 4 according to the teachings of the present invention. With reference to FIGS. 4-6, the steps of the method will now be explained. In step 300, the submersible device 200 is preprogrammed with all necessary operational data to operate within the water. For example the operation data may include information on pre-contact searching patterns and depths for the submersible device to operate. In addition, the employment of the sensor equipment (e.g., sonar transducer 230) may be programmed for detecting marine species as well as identifying a targeted marine species, such as fish. The submersible lure may also be programmed to calculate an intercept pattern for the submersible lure to operate upon detection of the targeted marine species. Next, in step 302, the submersible device is operated within the water. The submersible device is preferably towed within the water. However, in an alternate embodiment of the submersible lure, the lure may be self-propelled. In addition, the submersible device 200 tows other catching equipment, such as a net, artificial or natural bait or other capturing equipment. In step 304, the submersible device searches for the targeted marine species. In step 306, it is determined if the marine species is detected. If the marine species is not detected and identified by the intelligence module 220, the submersible lure goes to step 304 and continues to search for the targeted marine species.

However, in step 306, if the submersible lure detects and identifies the targeted marine species, the intelligence module 220 calculates an intercept approach to the detected marine species. The submersible lure may also communicate with a surface vessel providing information on anything detected by the submersible lure, whether the detected object is or is not the desired marine species. Next, in step 308, the submersible device executes the calculated intercept approach. This approach is calculated in such a manner to optimize the chances of enticing the marine species to enable capture by the catching device towed by the submersible device. In step 310, the submersible device executes the calculated intercept approach to the detected marine species. The fishing line clip may provide an indication if the attached bait or lure is detached or if a strike has occurred upon the bait or lure.

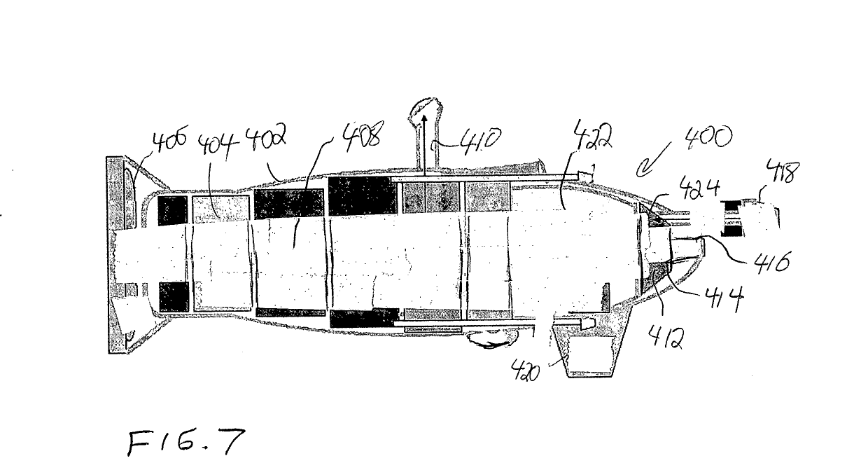

In a third embodiment of the present invention, a plurality of submersible pods 400 may be deployed by air or a surface service platform, such as a ship. The submersible pods may be used to contain a specified marine species by locating, tracking and controlling the species movement in direction and depth. One or more of the submersible pods may be utilized to accomplish the desired task. FIG. 7 is a side view illustrating the internal components of the submersible pod in the third embodiment of the present invention. The submersible pod 400 includes a main body 402 housing an electric motor 404 driving a propeller 406. The electric motor may be powered by a power source such as a battery 408. The submersible pod may include a side/down sonar system 410, an electronics module 412 having an intelligence module 414, a front sonar system 416, and a GPS/communication antenna 418. To maneuver through the water, the submersible pod 400 may utilize moveable control surfaces 420 and a ballast system 422 for depth control. The main body also houses a communication system 424.

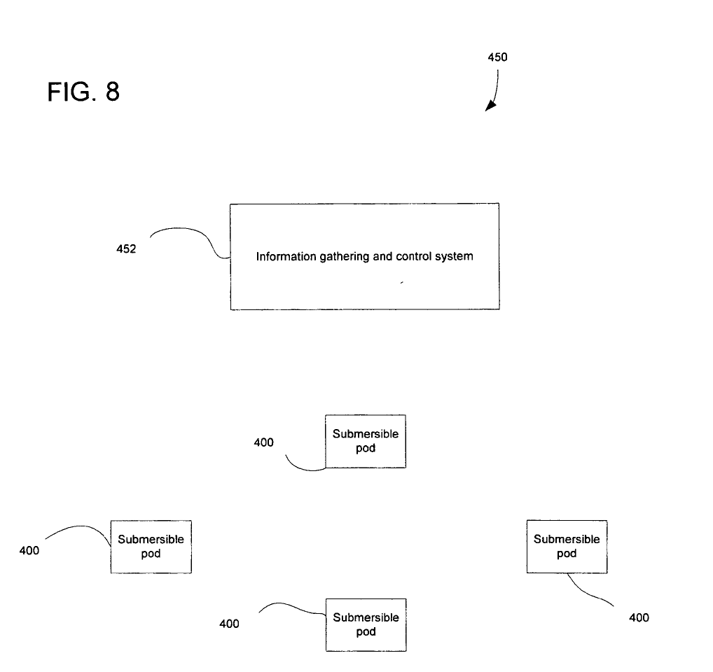

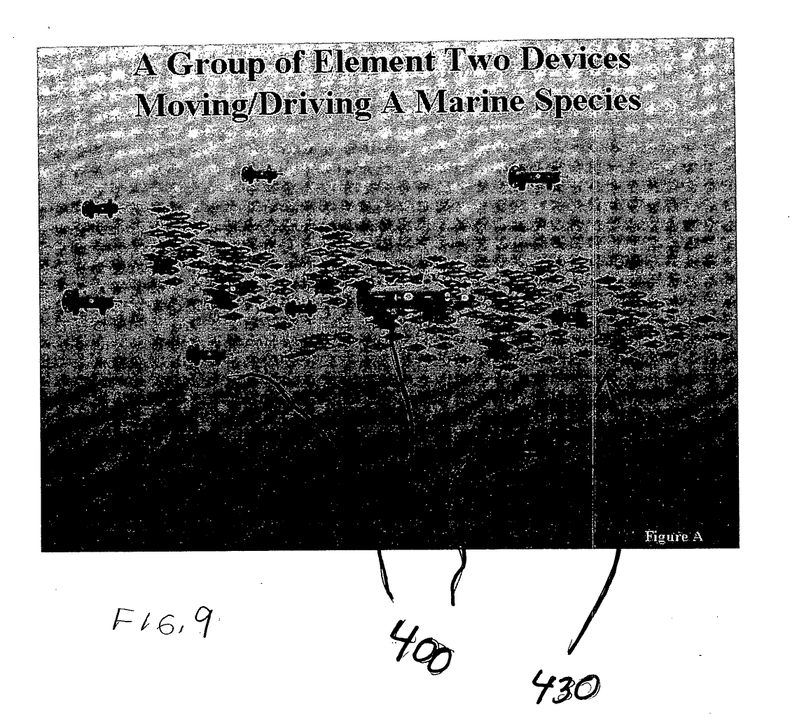

FIG. 8 is a simplified block diagram of the components of a control system 450 employing a plurality of submersible pods 400. The system 450 includes an information gathering and control system 452, which receives information on the plurality of submersible pods 400. In addition, the information gathering and control system 452 provides a remote control capability to control the plurality of submersible pods remotely.

FIG. 9 is a side perspective view of a plurality of submersible pods 400 operating underwater to control a school of fish 430. The plurality of submersible pods may be arranged to herd one or more of the marine species to a specific location. The control of the marine species may be to repulse the marine species away from a specific area or to herd or attract the marine species to a specific location for gathering of the marine species.

The propulsion system may be any system allowing the submersible pod 400 to travel underwater. As depicted, an electric motor is used to drive a propeller. However, any propulsion system and maneuvering system may be used to accomplish the task of maneuvering the submersible pod 400 underwater. In addition, although a sonar system is depicted, any sensor system or combination of several sensor systems may be employed, such as visual acquisition equipment, radar, etc.

With reference to FIGS. 7-9, the operation of the submersible pod 400 will now be explained. Preferably, the submersible pod is employed with several other submersible pods. However, in an alternate embodiment of this invention, the submersible pod may operate individually. The submersible pods are deployed from a surface service platform such as a ship or be air dropped into the water. Prior to deployment of the submersible pod, the intelligence module is preprogrammed to follow a specific maintenance/search pattern. In addition, the intelligence module is programmed to develop an intercept and approach pattern as well as a system for controlling the marine species. After deployment, the submersible pod goes into a maintenance/search mode. In this mode, the submersible pod maintains system operations, such as power charge, runs system diagnostic checks, location acquisition (such as from GPS), information processing, and communication between the plurality of pods and the information gathering and control system 452. The information gathering and control system is preferably located on a surface vessel. However, in alternate embodiments of the present invention, the information gathering and control system may be located anywhere, including within a submersible pod. The submersible pods may communication with other submersible pods or the information gathering and control system through communication system 424. In order to facilitate the coordination of the pods, one of the pods may be designated the master pod with the other slave pods following commands from the master pod. The slave pods may also perform a “sanity check” upon the master pod. If the master pod does not conform to the expectations or parameters of a designated number of slave pods, the master pod may be undesignated as master pod and another pod selected for the master pod role. Additionally, one or more of the pods may consult the information gathering and control system to determine a correct course of action or which pod is designated as the master pod. It should be understood that all the pods have the intelligence to perform the master pod role. The submersible pod conducts a continual search for the desired marine species with its sensor system, utilizing equipment such as sonar equipment, visual acquisition equipment and other means as required to find the desired marine species.

Once the desired marine species is detected by one of the submersible pods, the speed, direction and position of the marine species will be identified by the submersible pod. The acquisition data is then transmitted to the other submersible pods and/or information gathering and control system 452 via the communication system 424. Next, the intelligence module 414 in one or more of the submersible pods then develops a plan to control the movement of the desired marine species. Next, the plurality of submersible pods submerge and start moving the species in a coordinated manner as programmed prior to deployment. The plurality of submersible pods maneuver through the water by a combination of ballast tanks propulsion drives and moveable control surfaces. To control the movement of the marine species, the submersible pods employ equipment emitting sonic waves, electronic fields, etc. as well as the positioning of each pod in a location to control the marines species to a desired location.

Once the marine species is positioned in the desired location, the submersible pods communicate their position to the command and control system. The submersible pods may be optionally remotely controlled as necessary to accomplish or terminate the assigned mission. The submersible pods may then return to the surface where they are retrieved and serviced for another deployment.

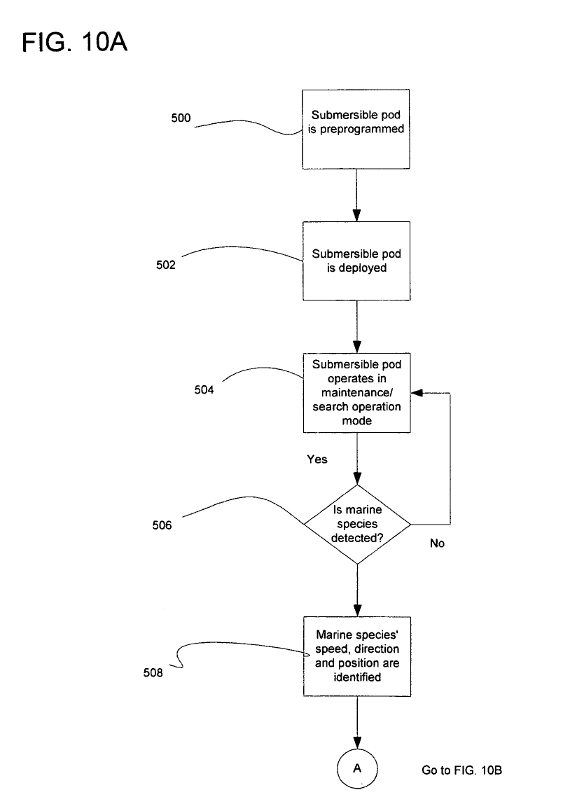

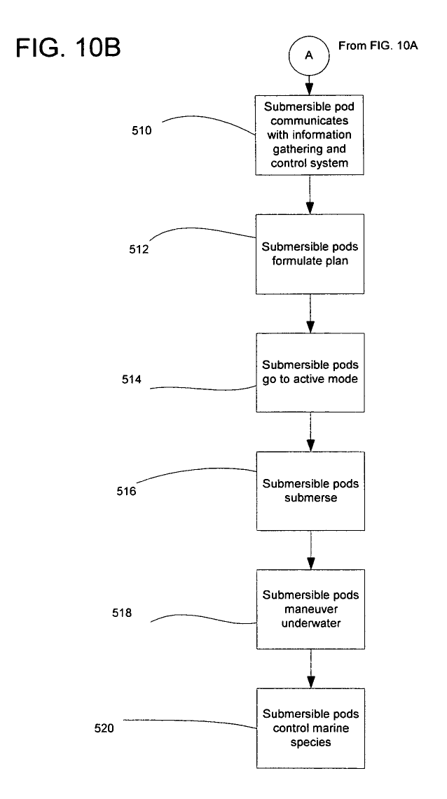

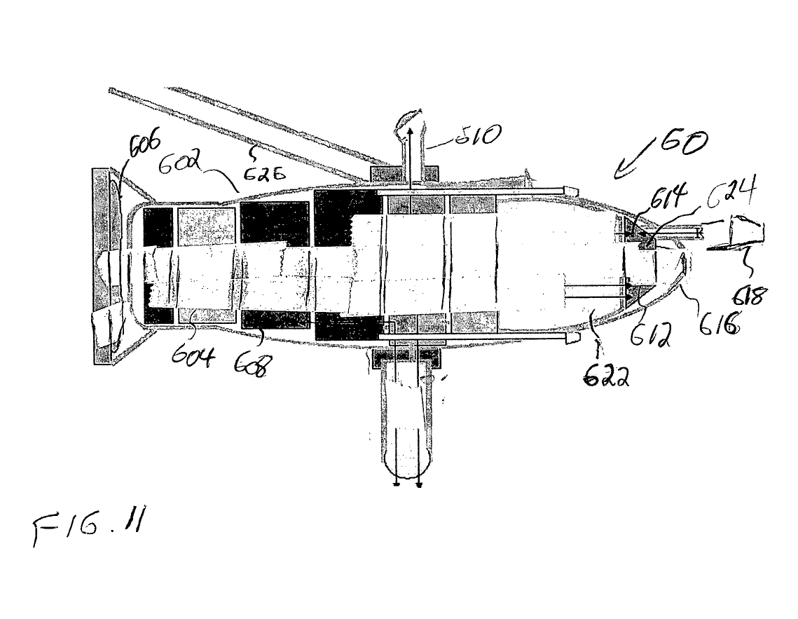

FIGS. 10A and 10B are flow charts outlining the steps for utilizing the submersible pod of FIG. 7 according to the teachings of the present invention. With reference to FIGS. 7-10, the steps of the method will now be explained. In step 500, the submersible pod 400 is preprogrammed through the intelligence module 414 with all necessary operational data to operate within the water. For example, the operational data may include information on pre-contact searching patterns and depths for the submersible pod to operate. In addition, the employment of the sensor equipment (e.g., sonar transducer 230) may be programmed for detecting marine species as well as identifying a targeted marine species, such as fish. Additionally, the submersible pod may be preprogrammed to operate in conjunction with other submersible pods.

The submersible pod may also be programmed to calculate an intercept pattern for the submersible pod to operate upon detection of the targeted marine species. Next, in step 502, the submersible pod is deployed within the water. In step 504, the submersible pod is employed in a maintenance/search mode. In this mode, the submersible pod maintains systems operation (i.e., power charge, runs system diagnostics, location acquisition, information processing, and communication to and from the information gather and control system). In addition, each submersible pod, in conjunction with other submersible pods, conducts a continual search for the desired species with its sensors (i.e., sonar equipment, visual acquisition equipment and other equipment as required). Next, in step 506, it is determined if the marines species is detected by one or more of the submersible pods. If it is determined that no marine species is detected, the method moves back to step 504 where searching continues.

However, in step 506, if it is determined that the marine species is detected, the method moves from step 506 to step 508 where the marine species' speed, direction and position are identified. Next, in step 510, the submersible pod communicates with the information gathering and control system 452 and other deployed submersible pods providing the relevant data. The method then moves to step 512 where the submersible pods formulate a plan to control the movement of the detected marine species. This plan is preprogrammed within the intelligence module before deployment of the submersible pods. As discussed above, a master pod is preferably designated to perform the lead role with the other pods following the master pod's direction. The master pod may optionally request concurrence on a course of action from the other pods or the information gathering and control system. In step 514, the submersible pods go into an active mode. Next, in step 516, the submersible pods submerse underwater.

Next, in step 518, the submersible pods move underwater utilizing propulsion systems, ballast systems, and moveable control surfaces to maneuver underwater. In step 520, the submersible pods control the species movement by various means, such as employing sonic waves, electromagnetic fields or by the positioning of the pod to intercept the marine species. After moving the detected marine species to the desired location, the submersible pods are retrieved and serviced for future deployments.

In a fourth embodiment of the present invention, a plurality of submersible pods 600 may be employed to detect and capture a desired marine species. FIG. 11 is a side perspective view of the internal components of the submersible pod 600 in the fourth embodiment of the present invention. The submersible pod 600 includes a main body 602 housing an electric motor 604 driving a propeller 606. The electric motor may be powered by a power source such as a battery 608. The submersible pod may include a side/down sonar system 610, an electronics module 612 having an intelligence module 614, a front sonar system 616, and a GPS/communication antenna 618. A ballast system 622 may be used for depth control. The main body also houses a communication system 624. The above components provide a similar function as discussed for the submersible pod 400. However, the submersible pod 600 may also be connected with other submersible pods. The submersible pod 600 may include a net brace 626 providing a physical connection to a net carried by several submersible pods.

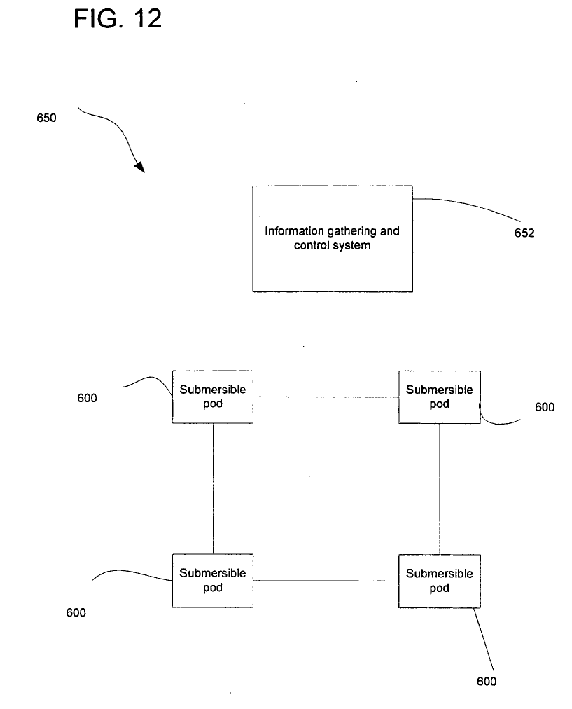

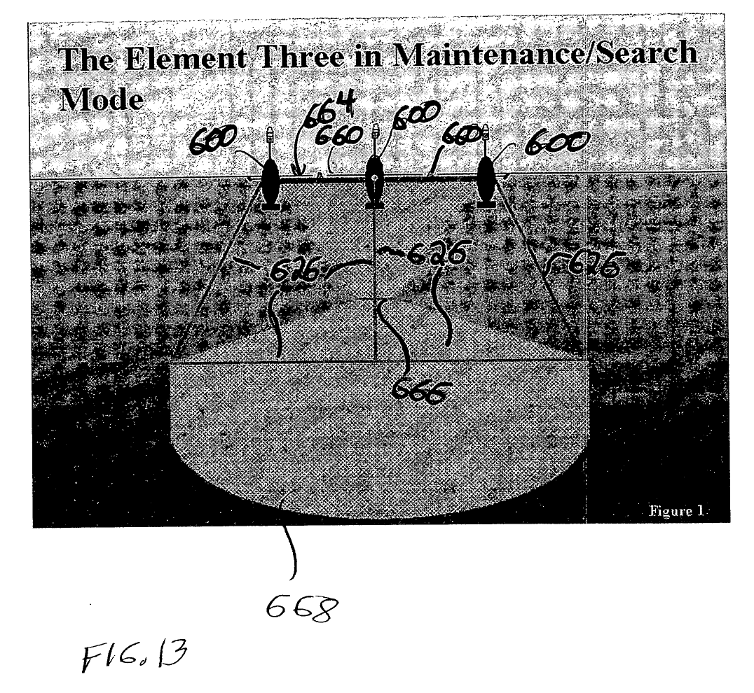

FIG. 12 is a simplified block diagram of the components of a control system 650 employing a plurality of submersible pods 600. The system 650 includes an information gathering and control system 652, which receives information on the plurality of submersible pods 600. In addition, the information gathering and control system 652 provides a remote control capability to control the plurality of submersible pods remotely.

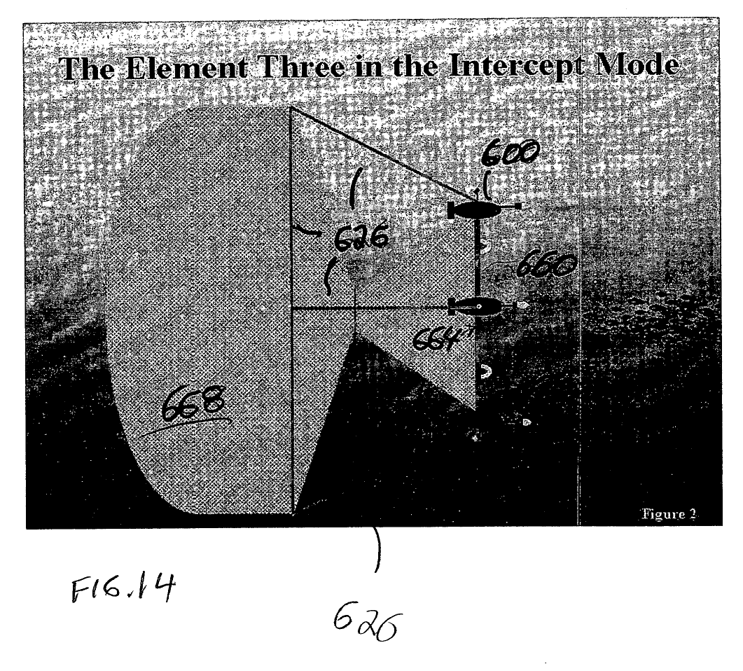

FIG. 13 is a side view of a plurality of submersible pods 600 in the maintenance/search mode in the fourth embodiment of the present invention. In the maintenance/search mode, the submersible pods remain floating on the water while actively searching underwater. The submersible pods 600 are connected together at junctions 660. Each submersible pod holds a net 662 at the net brace 626. Preferably, the net includes an open-ended mouth 664 narrowing into an opening 666 leading to a gathering area 668. After deployment, the submersible pods 600 go into the maintenance/search mode. In this mode, each submersible pod maintains a maintenance standby (i.e., power charge, runs system diagnostic check, location acquisition, information processing, and communications to and from the service platform). During this mode, each submersible pod analyzes if repair or replenishment of fuel is required by performing a self-diagnostic check on itself. If a visit from the service platform (e.g., ship) is required, the submersible remains on the surface and communicates with the service platform. Service or redeployment of the pod can then be performed by the service platform as required. If a visit is not required by the service platform or after completion of the visit, each submersible pod returns to the maintenance/search mode where a continuous search for a desired marine species with the pods' sensors is conducted.

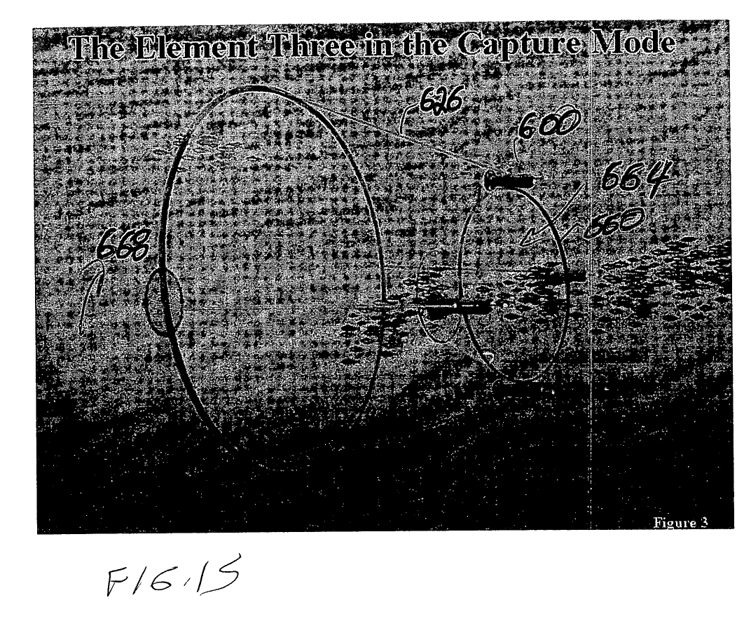

When the submersible pods 600 detect the desired marine species, the location, speed and position of the marine species is identified. In addition, the submersible pods calculate if an interception is possible. The submersible pods communicate with the service platform and convey any relevant data as well as the plan to intercept and capture the marine species. If the submersible pods determine that an intercept is practical, the submersible pods go into an intercept mode. FIG. 14 is a side perspective view of the plurality of submersible pods 600 in the intercept mode. The submersible pods submerge and maneuver through the water to intercept the marine species. The submersible pods controls its position employing a combination of ballast tanks, propulsion drives and moveable control surfaces. If the marine species changes direction and/or speed, the submersible pods correct its direction and speed to compensate for the change.

The submersible pods 600 then capture the marine species by gathering the marine species through opening 664 and storing the captured marine species in the gathering area 668. FIG. 15 is a side perspective view of the submersible pods 600 in the capture mode. During the capture mode, the submersible pods analyze the success of the activity and make a determination when to return to the surface.

Once it is determined to return to the surface, each submersible pod 600 performs a self-diagnostic check upon itself and determines if repair, replenishing of fuel or removal of the captured marine species is necessary. The submersible pods communicate with the service platform with its location, status and requirements. If a visit from the service platform is required, the submersible pod will remain on the surface awaiting servicing by the service platform. If a visit is not required by the service platform or after the visit is complete, the device returns to the maintenance/search mode.

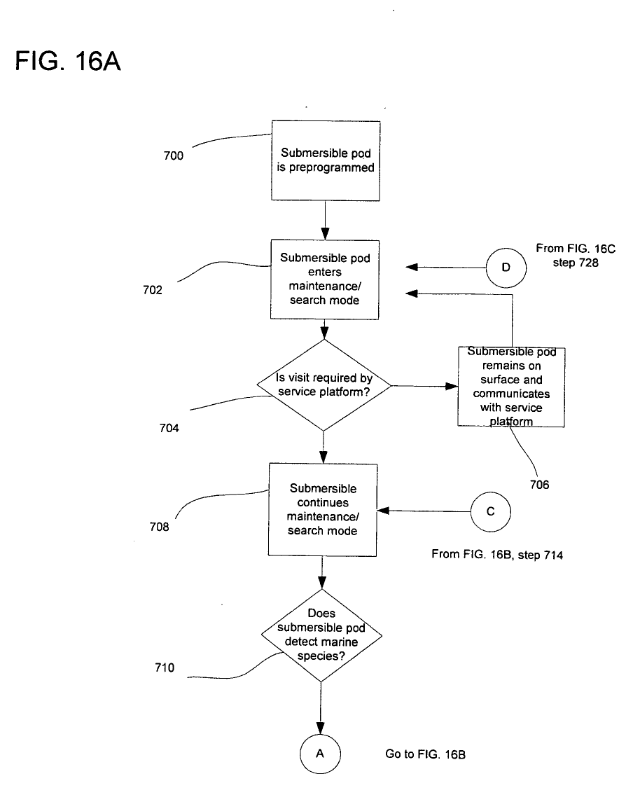

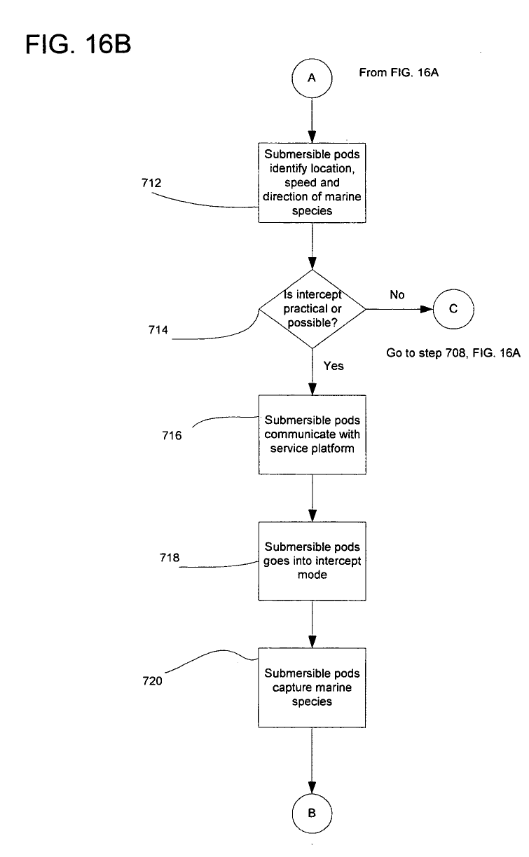

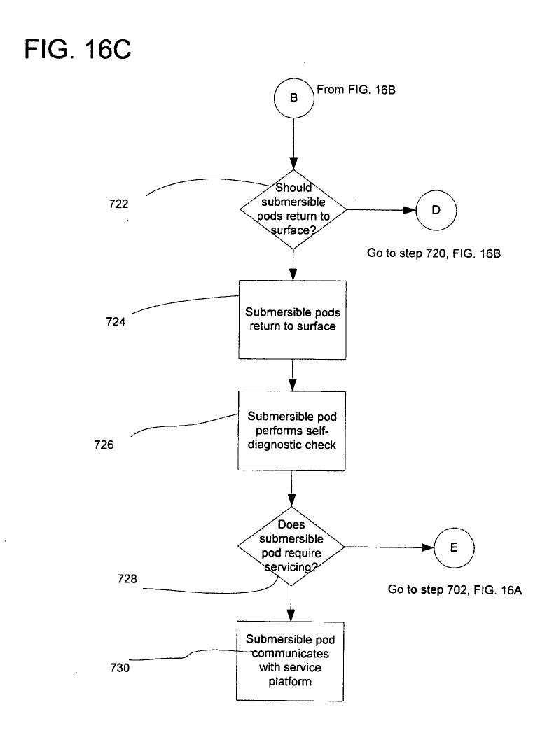

FIGS. 16A and 16B are flow charts outlining the steps for utilizing the submersible pod 600 of FIG. 11 according to the teachings of the present invention. With reference to FIGS. 11-16, the steps of the method will now be explained. In step 700, the submersible pod 600 is preprogrammed, through the intelligence module 614, with all necessary operation data to operate within the water. For example the operational data may include information on pre-contact searching patterns and depths for the submersible pod to operate. In addition, the employment of the sensor equipment (sonar, etc.) may be programmed for detecting marine species as well as identifying a targeted marine species, such as fish. Additionally, the submersible pod may be preprogrammed to operate in conjunction with other submersible pods. The submersible pod may also be programmed to calculate an intercept pattern for the submersible lure to operate upon detection of the targeted marine species.

Next, in step 702, the submersible pods 600 enter the maintenance/search mode. In the maintenance/search mode, the submersible pods remain floating on the water while actively searching underwater. The submersible pods 600 are connected together at junctions 660. Each submersible pod holds the net 662 at the net brace 626. Preferably, the net includes the open-ended mouth 664 narrowing into the opening 666 leading to the gathering area 668. The submersible pods enter the maintenance/search mode upon deployment into the water. In this mode, each submersible pod maintains a maintenance standby (i.e., power charge, runs system diagnostics, location acquisition, information processing, and communications to and from the service platform). Next, in step 704, each submersible pod analyzes if repair or replenishment of fuel is required by performing a self-diagnostic check upon itself. If it is determined that a visit to the service plat form is required, the method moves to step 706 where the submersible pod remains on the surface and communicates with the service platform. Service can then be performed by the service platform as required.

However, in step 704 if it is determined that a visit is not required by the service platform or after completion of the visit, the method moves to step 708 where each submersible pod returns to the maintenance/search mode. In the maintenance/search mode, each submersible pod continuously searches for a desired marine species by utilizing the pods' sensors.

Next, in step 710 it is determined if the submersible pods detect the desired marines species. If it is determined that the submersible pods do not detect the marine species, the method moves to step 708. However, if it is determined that the marine species is detected, the method moves to step 712 where the submersible pods 600 identify the location, speed and position of the marine species. Next, in step 714, the submersible pods determine if an intercept is possible or practical. If it is determined that an intercept is not possible or impractical, the method moves to step 708 and where the submersible pod remains in the maintenance/search mode. However, if it is determined that an intercept is possible or practical, the method moves from step 714 to step 716 where the submersible pods communicate with the service platform and convey any relevant data as well as the plan to, intercept and capture the marine species. Next, in step 718, the submersible pods 600 go into an intercept mode. In the intercept mode, the submersible pods submerge and maneuver through the water to intercept the marine species. The submersible pods control their position employing a combination of ballast tanks, propulsion drives and moveable control surfaces. If the marine species changes direction and/or speed, the submersible pods correct their direction and speed to compensate for the change.

Next, in step 720, the submersible pods 600 then capture the marine species by gathering the marine species through the opening 664 and storing the captured marine species in the gathering area 668. Next in step 722, the submersible pods determine if it is necessary to return to the surface by the submersible pods analyzing the success of the activity. If it is determined that the submersible pods 600 should stay underwater, the method moves to step 720 and continues to operate in the capture mode. However, in step 722, if it is determined that the submersible pods should return to the surface, the method moves to step 724 where each submersible pod returns to the surface. Next, in step 726, each submersible pod 600 performs a self-diagnostic check upon itself. In step 728 it is determined if repair, replenishing of fuel or removal of the captured marine species is necessary. If it is determined that repair, replenishing of fuel or removal of the captured marine species' is necessary, the method moves to step 730 where the submersible pods communicate with the service platform with its location, status and requirements and requests a visit from the service platform. However, in step 728, if repair replenishment or removal of captured marine species is not necessary, the submersible pod goes to step 702 where the submersible pod remains in the maintenance/search mode.

Although dive planes or moveable control surfaces are used to maneuver the different embodiments of the submersible devices underwater, any device or devices may be utilities to maneuver any embodiment of the submersible devices within the water. In addition, the intelligence module in each submersible device may include the capability to communicate with the user and/or the information gathering and control system by providing information detected by the sensory equipment or any action taken by the submersible device. The communication between the user and/or information gathering and control system may be via sonic waves, electromagnetic waves and/or a tether/wire.

The present invention provides an autonomous submersible device which can locate, intercept, control and gather various marine species. The present invention includes a submersible device which has an intelligence module which can detect, develop a plan to intercept or control the detected marine species, as well as capture the marine species. The submersible device may work alone or in combination with other submersible devices. In addition, the submersible device may be towed by a ship or be self-propelled. The submersible device may optionally include a communication system to communicate with a remotely located control system. The submersible device also includes sensor equipment for detecting the marine species. The submersible device is controlled through the utilization of a plurality of moveable control surfaces, ballast tanks, or other control mechanisms commonly used by underwater submersibles.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A submersible device for interacting with a marine species, the submersible device comprising:
a main body housing an intelligence module;
means for maneuvering the main body underwater; and
sensor equipment within the main body for detecting marine species;
the intelligence module being programmed to maneuver the main body in a desired pattern to accomplish a desired course of action upon detection of a marine species.

2. The submersible device for interacting with a marine species of claim 1 wherein the means for maneuvering underwater includes a plurality of moveable control surfaces controlled by the intelligence module.

3. The submersible device for interacting with a marine species of claim 1 wherein the means for maneuvering underwater includes a buoyancy system for varying the depth of the main body while traveling underwater.

4. The submersible device for interacting with a marine species of claim 1 wherein the means for maneuvering underwater includes a moveable diveplane attached to the main body for varying the depth of the main body while traveling underwater.

5. The submersible device for interacting with a marine species of claim 1 wherein the main body is towed by a surface vessel, the main body being towed by the surface vessel while maneuvering underwater.

6. The submersible device for interacting with a marine species of claim 1 wherein the main body is self-propelled.

7. The submersible device for interacting with a marine species of claim 1 wherein the intelligence module calculates an intercept course upon detection of the marine species.

8. The submersible device for interacting with a marine species of claim 10 wherein the intelligence module calculates an intercept and captures the detected marine species.

9. The submersible device for interacting with a marine species of claim 1 wherein the intelligence module calculates a course of the main body to position the detected marine species in a desired location.

10. The submersible device for interacting with a marine species of claim 1 wherein the main body includes means for towing a fish catching device for capturing the marine species.

11. The submersible device for interacting with a marine species of claim 10 wherein the means for towing a fish catching device includes means for detecting the detachment of the fish catching device.

12. The submersible device for interacting with a marine species of claim 1 wherein the main body is a lure having at least one attached hook for capturing a marine species.

13. A system for interacting with a marine species, the system comprising:
a plurality of submersible pods, each submersible pod having:
a main body housing an intelligence module;
means for maneuvering the main body underwater; and
sensor equipment within the main body for detecting marine species;
the intelligence module being programmed to maneuver the main body in a desired pattern for a desired course of action with the marine species upon detection of a marine species; and
a controller for coordinating the plurality of submersible pods to maneuver in a desired pattern to accomplish the desired course of action with the marine species.

14. The system for interacting with a marine species of claim 13 wherein the plurality of submersible pods tow a net for capturing the marine species.

15. The system for interacting with a marine species of claim 13 wherein the means for maneuvering underwater by each submersible pod includes a plurality of moveable control surfaces controlled by the intelligence module.

16. The system for interacting with a marine species of claim 13 wherein the main body of each submersible is towed by a surface vessel, the main body of each submersible being towed by the surface vessel while maneuvering underwater.

17. The system for interacting with a marine species of claim 13 wherein each submersible pod is self-propelled.

18. The system for interacting with a marine species of claim 13 wherein each submersible pod operates in coordination with the other submersible pods while the intelligence module of each submersible pod calculates an intercept course upon detection of the marine species.

19. The system for interacting with a marine species of claim 13 wherein the plurality of submersible pods intercepts and captures the detected marine species.

20. The system for interacting with a marine species of claim 13 wherein each submersible pod through the intelligence module calculates a course of the submersible pod to position the detected marine species in a desired location.

21. The system for interacting with a marine species of claim 13 wherein the plurality of submersible pods includes means for towing a fish catching device for capturing the marine species.

22. A method of interacting with a marine species, the method comprising the steps of:
maneuvering a submersible device underwater;
detecting a marine species;
calculating a course of action by the submersible device upon detection of the marine species; and
executing the course of action by the submersible device for interacting with the marine species.

23. The method of interacting with a marine species of claim 22 wherein the step of maneuvering a submersible device underwater includes utilizing a moveable control surface attached to the submersible device and ballast to control the depth of the submersible device.

24. The method of interacting with a marine species of claim 22 wherein the step of calculating a course of action includes intercepting the marine species.

25. The method of interacting with a marine species of claim 24 wherein the step of intercepting the marine species includes capturing the marine species.

26. The method of interacting with a marine species of claim 25 further comprising the step of towing a capture device by the submersible pod, the net capturing the marine species.

27. The method of interacting with a marine species of claim 22 further comprising the step of coordinating the submersible pod with a plurality of submersible pods to execute the course of action.

28. The method of interacting with a marine species of claim 27 wherein the course of action is intercepting capturing the marine species by the plurality of submersible pods.
